(19) United States
(12) Patent Application Publication
(10) Pub. No.: US 2015/0322287 A1
(43) Pub. Date: Nov. 12, 2015

(54) LIGHT-CURABLE EPOXY COATING

(71) Applicant: Bell Helicopter Textron Inc., Fort Worth, TX (US)

(72) Inventors: Michael Ishmael, Bedford, TX (US); Frank Bradley Stamps, Colleyville, TX (US); Daniel P. Sottiaux, Flower Mound, TX (US)

(73) Assignee: BELL HELICOPTER TEXTRON INC., Fort Worth, TX (US)

(21) Appl. No.: 14/689,374

(22) Filed: Apr. 17, 2015

Related U.S. Application Data
(60) Provisional application No. 61/991,748, filed on May 12, 2014.

(51) Int. Cl. C09D 163/00; B64F 5/00; B05D 3/02; B64C 27/06; B05D 5/00

(52) U.S. Cl. CPC C09D 163/00; B64C 27/06; B05D 5/005; B05D 3/0254; B64F 5/0081

(57) ABSTRACT

According to one embodiment, a rotorcraft includes a body, a rotor system with a blade, and a component. The rotor system is coupled to the body of the rotorcraft. The component includes a metal portion, a temperature-sensitive portion adjoined to the metal portion, and a light-cured epoxy layer on the surface of the metal portion.

### RELATED APPLICATIONS

Pursuant to 35 U.S.C. §119(e), this application claims priority to U.S. Provisional Patent Application Ser. No. 61/991,748, entitled LIGHT-CURED EXPOXY COATING, filed May 12, 2014. U.S. Provisional Patent Application Ser. No. 61/991,748 is hereby incorporated by reference.

### TECHNICAL FIELD

This invention relates generally to an aircraft, and more particularly, to a method of protecting a component of the aircraft with a light-cured epoxy coating.

### BACKGROUND

A rotorcraft may include one or more rotor systems. One example of a rotorcraft rotor system is a main rotor system. A main rotor system may generate aerodynamic lift to support the weight of the rotorcraft in flight, and thrust to counteract aerodynamic drag and move the rotorcraft in forward flight. Another example of a rotorcraft rotor system is a tail rotor system. A tail rotor system may generate thrust in the same direction as the main rotor system's rotation to counter the torque effect created by the main rotor system.

### SUMMARY

Particular embodiments of the present disclosure may provide one or more technical advantages. A technical advantage of one embodiment may include the capability to prevent corrosion on a component of a rotorcraft. A technical advantage of one embodiment may include the capability to prevent mechanical wear, such as fretting, on a component of a rotorcraft. A technical advantage of one embodiment may include the capability to reduce the cost of a new or repaired component of a rotorcraft.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 shows a rotorcraft according to one example embodiment;

FIG. 2 shows a perspective view of a component of a rotorcraft according to one example embodiment;

FIG. 3 shows a perspective view of a component of a rotorcraft according to one example embodiment; and

FIG. 4 shows a perspective view of a component of a rotorcraft according to one example embodiment.

### DETAILED DESCRIPTION OF THE DRAWINGS

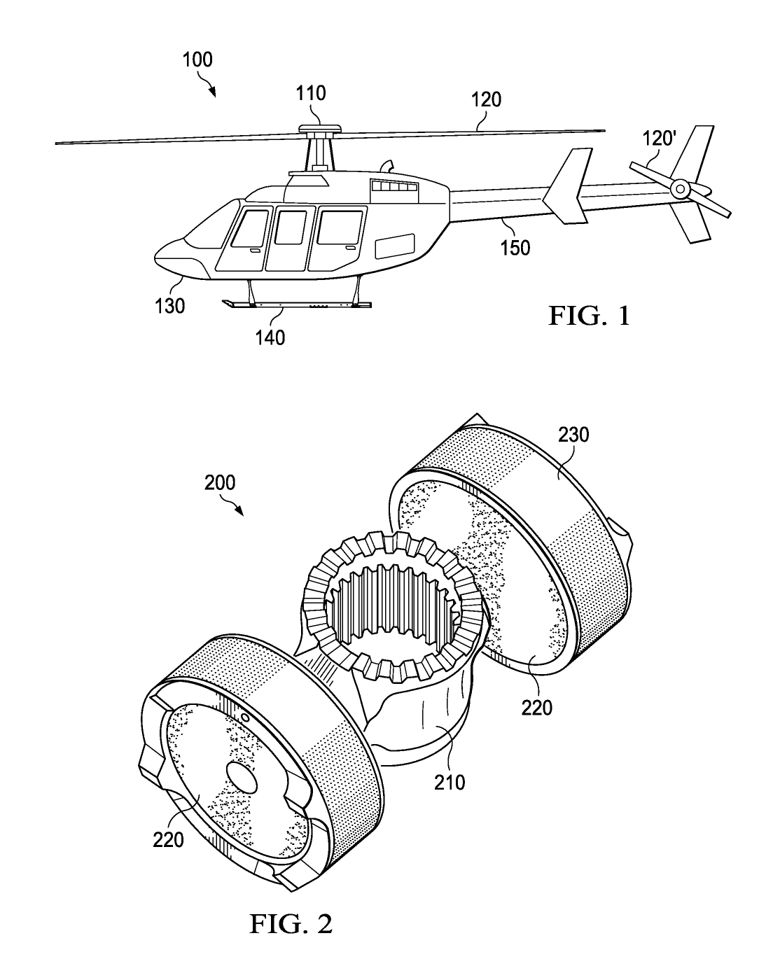

FIG. 1 shows a rotorcraft 100 according to one example embodiment. Rotorcraft 100 features a rotor system 110, blades 120, a fuselage 130, a landing gear 140, and an empennage 150. Rotor system 110 may rotate blades 120. Rotor system 110 may include a control system for selectively controlling the pitch of each blade 120 in order to selectively control direction, thrust, and lift of rotorcraft 100. Fuselage 130 represents the body of rotorcraft 100 and may be coupled to rotor system 110 such that rotor system 110 and blades 120 may move fuselage 130 through the air. Landing gear 140 supports rotorcraft 100 when rotorcraft 100 is landing and/or when rotorcraft 100 is at rest on the ground. Empennage 150 represents the tail section of the aircraft and features components of a rotor system 110 and blades 120′. Blades 120′ may counter the torque effect created by rotor system 110 and blades 120. Teachings of certain embodiments relating to rotor systems described herein may apply to rotor system 110 and/or other rotor systems, such as other tilt rotor and helicopter rotor systems. It should also be appreciated that teachings from rotorcraft 100 may apply to aircraft other than rotorcraft, such as airplanes and unmanned aircraft, to name a few examples.

Rotorcraft 100 and its components may be subject to a variety of different environmental conditions such as rain, salt water, dust, and sand. Rotorcraft and its components may also be exposed to certain substances such as acids, bases, fuels, solvents, and oils. These conditions and substances may cause the components of rotorcraft 100 to corrode. Additionally, rotorcraft 100 and its components may be subject to vibrations and high fatigue loads. These vibrations and high fatigue loads may cause the components of rotorcraft 100 to experience mechanical wear, such as fretting.

FIG. 2 shows just one example of a component that may be located on rotorcraft 100. In general, a component may represent any part that is located on rotorcraft 100 that may experience damage, such as corrosion or mechanical wear, if left unprotected. For example, component 200 of FIG. 2 may represent a flapping bearing that is coupled to the center of the hub of rotor system 110 in order to absorb the flapping force of the blades 120. Component 200 may include metal 210; metal 210 may represent any metal, such as stainless steel, titanium, or aluminum. Component 200 may include elastomer 220; elastomer 220 may represent any natural or synthetic rubber blend. Component 200 may include epoxy 230; epoxy 230 may represent any thermally-cured epoxy or light-cured epoxy. Epoxy 230 may be applied to component 200 as a corrosion or mechanical-wear barrier.

In one example, epoxy 230 is a thin layer of thermally-cured, epoxy-powdered coating that is applied to a component, such as component 200. Although thermally-cured epoxy has its advantages, such as controlling corrosion or mechanical wear, thermally-cured epoxy 230 may be damaged in downstream processes, during installation of component 200, or during overhaul and repair of component 200.

If the thermally-cured epoxy 230 is damaged, component 200 may need to be repaired. Component 200 may be repaired by stripping thermally-cured epoxy 230 from component 200 and reapplying a new layer of epoxy 230. Stripping thermally-cured epoxy 230 from component 200 may require epoxy 230 to be mechanically stripped from component 200 or immersed in an alkaline-type stripper.

Once thermally-cured epoxy 230 is stripped from component 200, component 200 may need to be recoated with thermally-curable epoxy 230. Recoating component 200 with thermally-curable epoxy 230 may involve placing component 200 in a fluidized bedchamber or electrostatically spraying thermally-curable epoxy 230 onto component 200. Once component 200 is coated with a new layer of thermally-curable epoxy 230, component 200 is then cured at approximately four hundred and fifty degrees Fahrenheit.

However, it has been discovered that if component 200 contains a temperature-sensitive material, such as elastomer 220, the heat from curing epoxy 230 may damage or weaken elastomer 220. Therefore, if the thermally-curable epoxy 230 is damaged and needs to be repaired, elastomer 220 may need to be removed from component 200 and then reinstalled after the curing of thermally-cured epoxy 230. Accordingly, it may not be preferable to use thermally-cured epoxy 230 in components that contain a temperature-sensitive material, such as elastomer 220.

Teachings of certain embodiments recognize the capability for a light-curable epoxy coating to replace thermally-curable epoxy coating for the mechanical wear or corrosion barrier on component 200. A light-curable epoxy may be used on new components or to repair the epoxy coating on existing components. Accordingly, epoxy 230 may represent a type of light-curable epoxy that may be used in order to prevent mechanical wear or corrosion.

One example of a light-curable epoxy may be a thixotropic or paste epoxy with a high glass transition temperature, with a shore-durometer hardness of greater than eighty, that is machinable, and that is resistant to water, acids, bases, fuels, solvents, and oils. MASTER BOND UV15-7TK1A, MASTER BOND UV25, EPO-TEK OG147, and EPO-TEK OG198-55 are examples of ultraviolet-curable epoxies. Additionally, MASTER BOND LED401 is an example of an epoxy that may be curable with a light-emitting diode (LED) light source.

After the surface of metal 210 is prepared, light-curable epoxy 230 may be applied to component 200 in a variety of ways, including spraying, brushing, or rolling on light-curable epoxy 230. After light-cured epoxy 230 is applied to component 200, light-cured epoxy 230 may be cured with light for approximately thirty seconds, depending on the thickness of epoxy applied and the type of light-curable epoxy. A lamp—such as a metal-halide lamp, doped-mercury lamp, or LED lamp—may be used to cure epoxy 230. Once light-cured epoxy 230 is cured, it may be machined to a desired thickness or shape.

Because light-cured epoxy 230 may not require a high temperature to cure, high temperatures do not damage elastomer 220; therefore, elastomer 220 may not need to be removed from component 200 prior to the curing of epoxy 230.

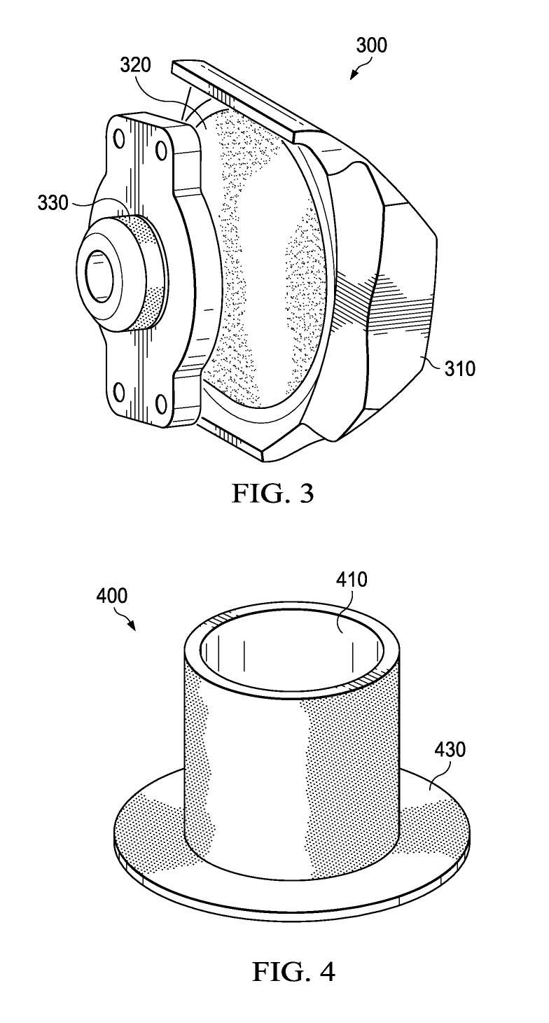

FIG. 3 shows another example of a component that may be located on rotorcraft 100. Component 300 may represent a centrifugal force bearing that is associated with each blade 120 and reacts and counteracts the compressional force exerted on blade 120 by compressing elastomer 220. Component 300 may also contain metal 310, elastomer 320, and epoxy 330. In the example of FIG. 3, metal 310 may have similar properties to metal 210, elastomer 320 may have similar properties to elastomer 220, and epoxy 330 may have similar properties to epoxy 230. Because elastomer 320 is a temperature-sensitive material, teachings of certain embodiments recognize the use of a light-curable epoxy 330 instead of a thermally-curable epoxy on components that contain elastomer.

FIG. 4 shows yet another example of a component that may be located on rotorcraft 100. Component 400 may represent a bushing that is located on blade 120 that can be configured to allow a blade bolt to couple blade 120 to rotor system 110. Component 400 may contain metal 410 and epoxy 430. Epoxy 430 may have similar properties to epoxy 230. In this example, metal 410 is aluminum. Aluminum may warp or lose its heat treatment when subjected to temperatures of approximately four hundred and fifty degrees Fahrenheit. Therefore, because aluminum is a temperature-sensitive material, teachings of certain embodiments recognize the use of a light-curable epoxy 430 instead of a thermally-curable epoxy on components that contain aluminum.

Many components of rotorcraft 100 may benefit from light-cured epoxy. For example, the elastomeric bearing disclosed in U.S. Publication No. 2014/0255191, which is hereby incorporated by reference, may represent a component that may benefit from light-cured epoxy. The centrifugal force bearing disclosed in U.S. Pat. No. 8,231,346, which is hereby incorporated by reference, may represent a component that may benefit from light-cured epoxy. The elastomeric bearing assembly disclosed in U.S. application Ser. No. 14/630,382, which is hereby incorporated by reference, may represent a component that may benefit from light-cured epoxy.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A rotorcraft, comprising:
a body;
a rotor system coupled to the body, the rotor system comprising a blade; and
a component, comprising:
a metal portion;
a temperature-sensitive portion adjoined to the metal portion; and
a light-cured epoxy layer on the surface of the metal portion.

2. The rotorcraft of claim 1, wherein the metal is a material selected from the group consisting of aluminum, titanium, and stainless steel.

3. The rotorcraft of claim 1, wherein the temperature-sensitive portion is an elastomer.

4. The rotorcraft of claim 1, wherein the temperature-sensitive portion is aluminum.

5. The rotorcraft of claim 1, wherein the light-cured epoxy layer is curable with ultra-violet light.

6. The rotorcraft of claim 1, wherein the light-cured epoxy layer is curable with a light emitting diode.

7. The rotorcraft of claim 1, wherein the component is a flapping bearing that is coupled to the center of the rotor system.

8. The rotorcraft of claim 1, wherein the component is a centrifugal force bearing that is coupled to the blade.

9. A method of repairing a component, comprising:
providing a component comprising a temperature-sensitive portion, a metal portion, and a damaged epoxy layer;
removing the damaged epoxy layer;
applying a light-curable epoxy layer to the surface of the metal portion; and
curing the light-curable epoxy layer with a light source, forming a cured epoxy layer.

10. The method of claim 9, wherein the metal is a material selected from the group consisting of aluminum, titanium, and stainless steel.

11. The method of claim 9, wherein the temperature-sensitive portion is an elastomer.

12. The method of claim 9, wherein the temperature-sensitive portion is aluminum.

13. The method of claim 9, wherein the light-curable epoxy layer is curable with ultra-violet light.

14. The method of claim 9, wherein the light-curable epoxy layer is curable with a light emitting diode.

15. The method of claim 9, wherein the light-curable epoxy layer is a thixotropic paste with a shore-durometer hardness of greater than eighty.

16. The method of claim 9, wherein the step of curing comprises using a lamp selected from the group consisting of a metal-halide lamp, doped-mercury lamp, and LED lamp.

17. The method of claim 9, further comprising:
machining the cured epoxy layer.

18. A method of protecting a component, the method comprising:
providing a component comprising a temperature-sensitive portion and a metal portion;
applying a light-curable epoxy layer to the surface of the metal portion; and
curing the light-curable epoxy layer with a light source, forming a cured epoxy layer.

19. The method of claim 18, wherein the temperature-sensitive portion is an elastomer.

20. The method of claim 18, further comprising:
machining the cured epoxy layer.
